(19) United States
(12) Patent Application Publication
(10) Pub. No.: US 2004/0173727 A1
(43) Pub. Date: Sep. 9, 2004

(54) Method for determining the angle of incidence of low level, periodic optical signals

(75) Inventors: William T. Krohn, Sandy Hook, CT (US); Thomas A. Carmody, Burlington, CT (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: GOODRICH CORPORATION

(21) Appl. No.: 10/377,407

(22) Filed: Mar. 3, 2003

(51) Int. Cl. G01J 1/00

(52) U.S. Cl. 250/206

(57) ABSTRACT

A method for determining an angle of incidence of periodic optical signals is provided. The method includes detecting whether the periodic optical signals are present; generating a pulsed output when the periodic optical signals are present, the pulsed output corresponding to peaks in the periodic optical signals; predicting a timing of the periodic optical signals from the pulsed output; controlling a gated detector array to take a first reading and a second reading of the periodic optical signals based upon the timing, the first reading being out of phase with the timing and the second reading being in phase with the timing; and generating the angle of incidence by filtering the first reading from the second reading.

### FEDERALLY SPONSORED RESEARCH AND DEVELOPMENT

This invention was funded with government support under contract No. DAA-B07-99-D-B032 awarded by the Department of the Army. The government may have certain rights in this invention as provided for by the terms of such contract.

### BACKGROUND OF THE INVENTION

1. Field of the Invention

The present invention is directed to a method for determining the angle of incidence of low level, periodic optical signals.

2. Description of Related Art

Military ordinance and weaponry have been used in conjunction with guidance systems using optical signals. The optical signals enable the guidance system to guide the weapon to that target (e.g., a beam rider). The optical signals are typically emitted, in the form of low power, low signal-to-noise laser signals. Weapons having such a guidance system (hereinafter referred to as “guided weapons”) have proven useful in increasing the effectiveness of offensive military operations.

The proliferation of guided weapons has given rise to the need for systems that can detect when an object has been targeted by such a weapon. For example, warning systems have been developed to detect the presence of the optical signals emitted to guide a weapon. Early detection of the optical signals can prove useful in preventing strikes by such guided weapons. For example, early detection of an optical signal from a guided weapon can allow a potential target to take evasive action to avoid the weapon. Alternately, early detection of an optical signal from a guided weapon can allow the potential target to enact countermeasures, such as emitting signals configured to confuse the guidance system of the incoming weapon, releasing weapons configured to destroy the incoming weapon, and combinations thereof.

In addition to merely detecting the presence of optical signals from guided weapons, it can be important for the warning system to determine where such signals are originating, i.e., the angle of incidence or the angle of arrival of such signals. However, prior art warning systems that detect both the presence of optical signals emitted by guided weapons and their angle of incident have proven to be less than optimal. For example, some warning systems present a video image of an incoming optical signal that requires further processing for detection and location. Here, the image can require the operator to process the signal in order to remove or filter out other non-laser sources (e.g., sun, light, etc.). Further, some prior art warning systems require the use of a gated image intensifier to minimize background noise, which has the unintended effects of limiting the spectral response of the system and increasing the cost of the system.

Due to the high cost of such prior art gated image intensifiers, the prior warning systems have used a moving or gimbaled sensor. However, the gimbaled sensor must first be moved to the sector where an incoming optical signal is detected, before further processing of the signal can occur. Thus, such gimbaled sensors can cause a delay in location determination. Moreover, if more than one incoming weapon is present, the gimbaled sensor can not simultaneously detect the multiple weapons. Further, the gimbaled sensor requires moving mechanical components. These moving mechanical components can decrease reliability of the system and/or can increase the weight of the system, which can be undesired aspects in military vehicles, such as airplanes, helicopters, armored personnel vehicles, and the like.

Accordingly, there is a continuing need for improved warning systems and methods of operation that address one or more of the aforementioned and other deficiencies in the prior art.

### BRIEF SUMMARY OF THE INVENTION

A method of determining the angle of incidence of low level, periodic optical signals is provided.

A method is provided for gating a detector to minimize interference of ambient or incident light on a low level optical signal and, thus, allow the angle of incidence of the optical signals to be easily determined.

A method is provided for determining an angle of incidence of periodic optical signals including: detecting whether the periodic optical signals are present; generating a pulsed output when the periodic optical signals are present, the pulsed output corresponding to peaks in the periodic optical signals; predicting a timing of the periodic optical signals from the pulsed output; controlling a gated detector array to take a first reading and a second reading of the periodic optical signals based upon the timing, the first reading being out of phase with the timing and the second reading being in phase with the timing; and generating the angle of incidence by filtering the first reading from the second reading.

A method for determining an angle of incidence of periodic optical signals is provided. The method includes: detecting whether said periodic optical signals are present; sending a pulsed output when said periodic optical signals are present, said pulsed output corresponding to peaks in the periodic optical signals; generating a synchronization pulse from said pulsed output, said synchronization pulse being indicative of an anticipated period of said periodic optical signals; gating a stationary optical detector array to take a first reading and a second reading of said periodic optical signals, said first reading being out of phase with said anticipated period and said second reading being in phase with said anticipated period; and generating said angle of incidence by filtering said first reading from said second reading.

Yet another aspect of the present invention is provided by a warning system having a first portion and a second portion. The first portion has a first optical detector and a pulse interval correlator, where the first optical detector sends an input to the pulse interval correlator. The second portion has a stationary gated optical detector, a predictive repeater, and a processor.

### BRIEF DESCRIPTION OF THE FIGURES

FIG. 1 illustrates an exemplary embodiment of a warning system according to the present disclosure.

### DETAILED DESCRIPTION OF THE INVENTION

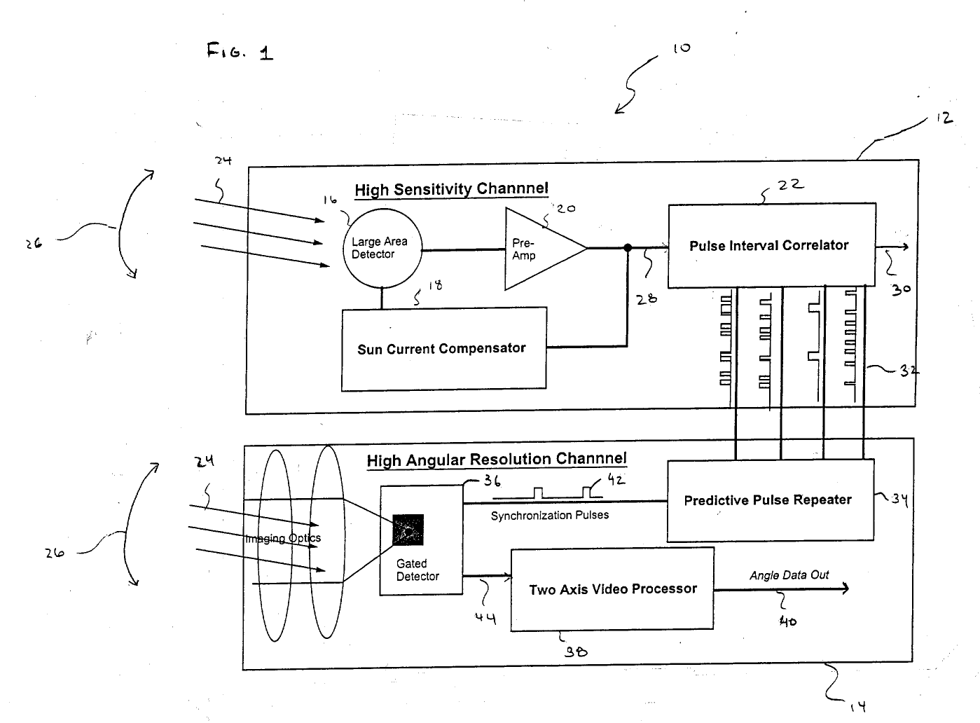

Referring now to FIG. 1, an exemplary embodiment of a warning system 10 according to the present disclosure is illustrated. Warning system 10 detects periodic, low-level optical signals and determines the angle incidence of these signals, a pair of parameters that have previously been considered mutually exclusive. Warning system 10 comprises a first channel 12 and a second channel 14. First channel 12 is preferably a high sensitivity channel and second channel 14 is preferably a high angular resolution channel.

First and second channels 12, 14 work in conjunction with one another to provide warning system 10 with the aforementioned low-level optical signal detection and angle of incidence capabilities. First channel 12 detects the presence or absence of the signals, and triggers second signal channel 14 to determine the angle of incidence of the detected signals.

First channel 12 includes a first optical detector 16, a filter 18, a signal amplifier 20, and a pulse interval correlator 22. First channel 12 is configured to control first optical detector 16 to detect the presence of periodic, low-level optical signals 24 originating in a detection range 26. Detection range 26, preferably, provides about ninety (90) degrees of azimuth and elevation detection.

First channel 12 processes signals 24 detected by detector 16 through filter 18 and amplifier 20 to provide a filtered and amplified input 28 to correlator 22. Filter 18 compensates signals 24 for interference from normal ambient sources, such as the sun, that are detected by detector 16. For example, filter 18 can apply a DC current load to signals 24, while amplifier 20 can amplify and/or boost signals 24.

Correlator 22 provides a warning output 30 to an operator indicative that signals 24 have been detected. Correlator 22 also converts inputs 28 into a series of digital pulse outputs 32 that correspond to peaks in periodic signals 24. Pulse outputs 32 are provided to second channel 14 for further processing. Thus, first channel 12 detects the presence of signals 24, alerts the operator, and sends pulse outputs 32.

First channel 12 continuously monitors range 26 for the presence of signals 24. Conversely, second channel 14 is normally dormant, i.e., is not monitoring range 26 for the presence of signals 24. However, second channel 14 is activated by the receipt of pulse outputs 32 from first channel 12. In essence, warning system 10 comprises two sub-systems where the first system detects the presence of incoming signals 24 and triggers the second system to determine the angle of incidence of such signals 24. Thus, first channel 12 alarms the operator of the detection of incoming signals 24 and sends output pulses 32 to trigger second channel 14, which then determines the angle of incidence of these signals.

Second channel 14 includes a predictive repeater 34, a gated optical detector 36, and a processor 38. Gated optical detector 36 is preferably an electronically gated optical detector array, and more preferably is an array of gated cameras, such as an array of charge-coupled device (CCD) cameras.

Predictive repeater 34 receives pulse outputs 32 from correlator 22, then analyzes and deciphers pulse outputs 32 to generate synchronization pulses 42. Synchronization pulses 42 are indicative of the anticipated timing of the next pulse of signal 24. Predictive repeater 34 is adapted to decipher both pulsed and chopped periodic, low-level optical signals, a capability that was previously unavailable. For example, signals 24 can be emitted in several different forms. Some signals 24 are emitted as pulsed signals, others are emitted as chopped signals, and still others are emitted as a combination of pulsed and chopped signals. Importantly, predictive repeater 34 is configured to detect both pulsed and chopped waveforms.

It has been determined that synchronizing the gating of detector 36 with the anticipated timing of the next pulse of signal 24 can be used to provide the angle of incidence of signal 24. Thus, second channel 14 uses synchronization pulses 42 to control the gating of gated detector 36 to send a plurality of gated inputs 44 to processor 38. Specifically, second channel 14 uses synchronization pulses 42 to electronically gate (i.e., switch on and off) detector 36 in a synchronous relationship with the arrival of signals 24 detected by first channel 12 to cause detector 36 to generate gated inputs 44.

Gated inputs 44 includes a first input that is out of phase with the arrival of signals 24 and a second input that is in phase with the arrival of signals 24. Thus, the first input is representative of the ambient radiation detected by detector 36 without signals 24 being present. Conversely, the second input is representative of the radiation detected by detector 36 with signals 24 being present. Processor 38 compares gated inputs 44 to filter ambient radiation from signals 24, which then allows the processor to generate an angle of incidence output 40 therefrom.

The synchronous gating of detector 36 with respect to the periodic rate of signals 24 minimizes interference in the detection of signal 24 by gated detector 36. Thus, second channel 14 is a temporal filtering means, which minimizes interference in the detection of signal 24. The reduced interference allows gated detector 36 to be less sensitive and hence inexpensive, yet still provide a higher resolution of gated inputs 44 than conventional systems. For example, gated detector 36 does not require an image intensifier used by conventional systems. Accordingly, warning system 10 uses low-cost digital electronics to precisely synchronize gated detector 36 with incoming radiation signal 24. This allows gated detector 36 to provide gated inputs when incoming signal 24 is both present and absent, which allows the summation of these inputs by processor 38 (e.g., cancellation of the first input from the second input) to minimizes the interference from surrounding illumination.

In the illustrated embodiment, warning system 10 provides about ninety (90) degrees of azimuth and elevation detection. Here, four warning systems 10 would be needed to provide three hundred and sixty (360) degrees of azimuth and elevation. Of course, it is contemplated by the present disclosure for warning system 10 to provide a larger or smaller detection range 26 and, thus, it is contemplated that the aforementioned 360 degrees of azimuth and elevation detection be provided by more or less than four warning systems 10.

In contrast to gimbaled sensors, optical detectors 16, 36 remain stationary. Thus, each warning system 10 provides 90 degrees of detection without moving mechanical components. The elimination of moving components can increase the reliability and reduce the weight of warning system 10 as compared to prior systems. By way of example only, a known prior gimbaled sensor system providing 360 degrees of detection has a weight of about eighty (80) pounds. In contrast, four warning systems 10, which provide the same 360 degrees of detection, have an overall weight of about forty (40) pounds. Thus, warning system 10 provides about a fifty percent (50%) reduction in weight as compared to conventional systems for the same range of detection.

It should also be noted that the terms “first”, “second”, and “third” and the like may be used herein to modify elements performing similar and/or analogous functions. These modifiers do not imply a spatial, sequential, or hierarchical order to the modified elements unless specifically stated.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

What is claimed is:

1. A method for determining an angle of incidence of periodic optical signals, comprising:
detecting whether said periodic optical signals are present;
generating a pulsed output when said periodic optical signals are present, said pulsed output corresponding to peaks in said periodic optical signals;
predicting a timing of said periodic optical signals from said pulsed output;
controlling a gated detector array to take a first reading and a second reading of said periodic optical signals based upon said timing, said first reading being out of phase with said timing and said second reading being in phase with said timing; and
generating said angle of incidence by filtering said first reading from said second reading.

2. The method as in claim 1, wherein said gated detector array is activated by receipt of said pulsed output.

3. The method as in claim 1, further comprising generating a warning output when said periodic optical signals are present.

4. The method as in claim 1, wherein said gated detector array is an array of gated cameras.

5. The method as in claim 1, wherein said periodic optical signals are selected from the group consisting of: pulsed signals, chopped signals, and combinations thereof.

6. The method as in claim 1, wherein said gated detector array is stationary.

7. A method for determining an angle of incidence of periodic optical signals, comprising:
detecting whether said periodic optical signals are present;
sending a pulsed output when said periodic optical signals are present, said pulsed output corresponding to peaks in the periodic optical signals;
generating a synchronization pulse from said pulsed output, said synchronization pulse being indicative of an anticipated period of said periodic optical signals;
gating a stationary optical detector array to take a first reading and a second reading of said periodic optical signals, said first reading being out of phase with said anticipated period and said second reading being in phase with said anticipated period; and
generating said angle of incidence by filtering said first reading from said second reading.

8. The method as in claim 7, wherein detecting whether said periodic optical signals are present comprises:
controlling a first optical detector, a filter, and an amplifier to detect said presence of said periodic optical signals originating in a detection range.

9. The method as in claim 8, wherein said detection range is about ninety degrees of azimuth and elevation.

10. The method as in claim 7, further comprising: generating a warning output when said periodic optical signals are present.

11. The method as in claim 7, wherein said stationary optical detector array is an array of charge-coupled device cameras.

12. The method as in claim 7, wherein generating a synchronization pulse comprises: inputting said pulsed output into a predictive repeater, said predictive repeater analyzing and deciphering said pulsed output to generate said synchronization pulse.

13. The method as in claim 12, wherein said periodic optical signals are selected from the group consisting of: pulsed signals, chopped signals, and a combination thereof.

14. A warning system, comprising:
a first portion having a first optical detector and a pulse interval correlator, said first optical detector sending an input to said pulse interval correlator; and
a second portion having a stationary gated optical detector, a predictive repeater, and a processor.

15. The warning system as in claim 14, wherein said input is indicative of a presence of periodic optical signals, said pulse interval correlator providing a series of digital pulse outputs to said predictive repeater, said series of digital pulse outputs corresponding to peaks in said periodic optical signals.

16. The warning system as in claim 15, wherein said pulse interval correlator also provides a warning output to an operator indicative of said presence of said periodic optical signals.

17. The warning system as in claim 15, wherein said predictive repeater receives said series of digital pulse outputs and gates said stationary gated optical detector to generate a first gated input that is out of phase with said periodic optical signals and a second gated input that is in phase with said periodic optical signals.

18. The warning system as in claim 17, wherein said processor generates an angle of incidence of said periodic optical signals by canceling said first gated input from said second gated input.

19. The warning system as in claim 14, wherein said first portion further comprises a filter for compensating said input for interference from normal ambient sources.

20. The warning system as in claim 19, wherein said first portion further comprises a signal amplifier for amplifying said input.

21. The warning system as in claim 14, wherein said stationary gated optical detector is an electronically gated optical detector array.

22. The warning system as in claim 21, wherein said electronically gated optical detector array is an array of gated charge-coupled device cameras.
